(19) United States
(12) Patent Application Publication
(10) Pub. No.: US 2025/0182730 A1
(43) Pub. Date: Jun. 5, 2025

(54) ACOUSTIC COATING COMPOSITION

(71) Applicant: ARMSTRONG WORLD INDUSTRIES, INC., Lancaster, PA (US)

(72) Inventor: Steven L. MASIA, Lancaster, PA (US)

(21) Appl. No.: 18/935,579

(22) Filed: Nov. 3, 2024

Related U.S. Application Data
(60) Provisional application No. 63/606,200, filed on Dec. 5, 2023.

(51) Int. Cl. G10K 11/162; C08K 3/22; C08K 3/26; C08K 3/30; C08K 3/34; C08K 5/17; C09D 7/61; C09D 131/04; E04B 1/84

(52) U.S. Cl. CPC G10K 11/162; C08K 3/22; C08K 3/26; C08K 3/30; C08K 3/34; C08K 5/175; C09D 7/61; C09D 131/04; E04B 1/84; C08K 2003/2241; C08K 2003/265; C08K 2003/3063

(57) ABSTRACT

Described herein is an acoustic building panel comprising a body having a first major surface opposite a second major surface and a side surface extending there-between, a coating applied to at least one of the first major surface, the second major surface, or the side surface, the coating comprising a foaming agent, a wetting agent, diatomaceous earth, a pigment composition, and wherein the coating is present in an amount ranging from about 16.0 g/ft² to about 90.0 g/ft².

### CROSS-REFERENCE TO RELATED APPLICATION

This application claims the benefit of U.S. Provisional Application No. 63/606,200, filed on Dec. 5, 2023. The disclosure of the above application is incorporated herein by reference.

### BACKGROUND

Interior building materials may be required to meet various visual characteristics to match a desired room aesthetic. However, previous attempts at formulating such coating compositions interfered with acoustic properties of the resulting building material. Therefore, the need exists for a coating that achieves the desired visual characteristics while achieving the desired acoustic performance for an acoustic building material.

### BRIEF SUMMARY

Some embodiments of the present invention include an acoustic building panel comprising: a body having a first major surface opposite a second major surface and a side surface extending there-between; a coating applied to at least one of the first major surface, the second major surface, or the side surface, the coating comprising: a foaming agent; a wetting agent; diatomaceous earth; a pigment composition; and wherein the coating is present in an amount ranging from about 16.0 g/ft² to about 90.0 g/ft².

Other embodiments of the present invention include an acoustic building panel comprising: a body having a first major surface opposite a second major surface and a side surface extending there-between; a coating applied to at least one of the first major surface, the second major surface, or the side surface, the coating comprising: a foaming agent; a wetting agent comprising an amphetoric compound; diatomaceous earth; a pigment composition; and wherein the building panel has an NRC value of at least 0.5.

Other embodiments of the present invention include an acoustic building panel comprising: a body having a first major surface opposite a second major surface and a side surface extending there-between, the body comprising an inorganic fiber; a coating comprising: a binder present in an amount ranging from about 3 wt. % to about 8 wt. % based on the total weight of the coating; a foaming agent present in an amount ranging from about 0.1 wt. % to about 2.0 wt. %; a wetting agent comprising an amphoteric compound, the wetting agent present in an amount ranging from about 0.1 wt. % to about 1.0 wt. % based on the total weight of the coating; diatomaceous earth present in an amount ranging from about 20 wt. % to about 30 wt. % based on the total weight of the coating; and a pigment composition in an amount ranging from about 50 wt. % to about 75 wt. % based on the total weight of coating; wherein the coating is applied directly to at least one of the first major surface of the body, the second major surface of the body, or the side surface of the body.

Other embodiments of the present invention include an acoustic building panel comprising a first major exposed surface opposite a second major exposed surface and a side exposed surface extending between the first and second major exposed surface, the acoustic building panel comprising: a body having a first major surface opposite a second major surface and a side surface extending there-between; an acoustic coating applied to the first major surface of the body, the acoustic coating comprising: a foaming agent; a wetting agent comprising an amphoteric compound; diatomaceous earth; a pigment composition; and wherein the first major exposed surface of the building panel comprises the acoustic coating and the second major exposed surface of the building panel comprises the second major surface of the body; and wherein the acoustic coating is porous thereby allowing airflow through the building panel between the first major exposed surface and the second major surface such that the building panel exhibits an airflow resistance less than 40 ohms.

Other embodiments of the present invention include an acoustic building system comprising: at least one support strut; at least one of the aforementioned acoustic building panels supported by the at least one support strut.

Other embodiments of the present invention include a coating composition for the production of acoustic building panels, the coating composition comprising: a liquid carrier; a solid component comprising: a foaming agent; a wetting agent; diatomaceous earth; a pigment composition; and wherein the coating composition has a solids content ranging from about 45% to about 75% based on the total weight of the coating composition.

Other embodiments of the present invention include a method of forming an acoustic building panel comprising: a) applying the aforementioned coating composition directly to at least one of a first major surface or a side surface of a body comprising a fibrous material; and b) drying the coating composition so that substantially all of the liquid carrier is removed from the coating composition to form an acoustic coating as part of the acoustic building panel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to the present invention;

FIG. 2 is a cross-sectional view of the building panel according to the present invention, the cross-sectional view being along the II line set forth in FIG. 1; and

FIG. 3 is a ceiling system comprising the building panel of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

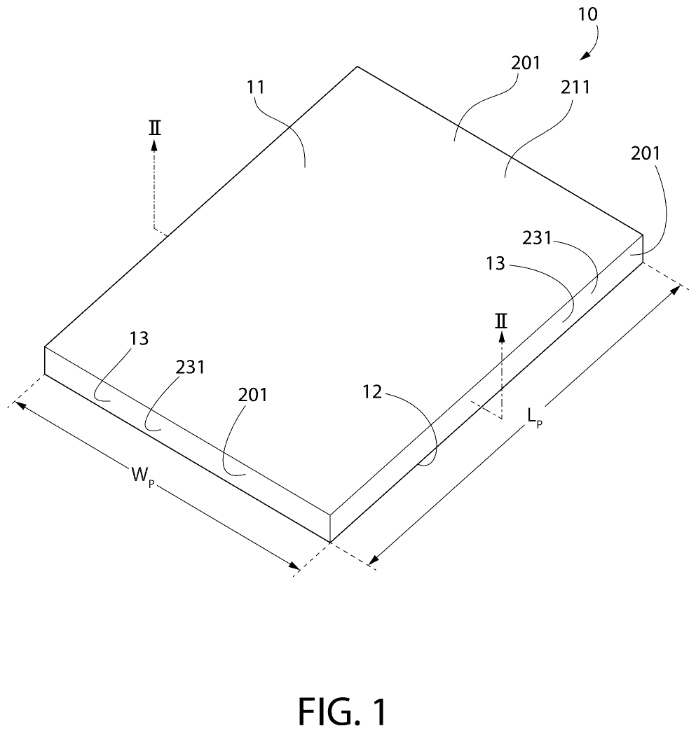

Referring to FIG. 1, the present invention includes a building panel 10 comprising a first major exposed surface 11 opposite a second major exposed surface 12 and a side exposed surface 13 that extends between the first major exposed surface 11 and the second major exposed surface 12, thereby defining a perimeter of the ceiling panel 10. The building panel 10 of the present invention may be referred to as an “acoustic building panel” 10—as discussed further herein.

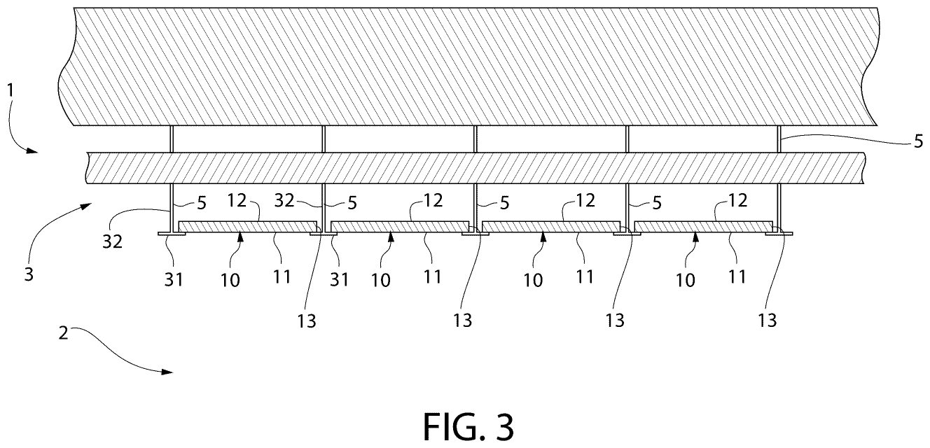

Referring to FIG. 3, the present invention may further include a building system 1 comprising one or more of the building panels 10 installed in an interior space, whereby the interior space comprises a plenum space 3 and an active room environment 2. In a non-limiting embodiment, the building system 1 may be referred to as a ceiling system. In such embodiments, the building panel 10 may be referenced as a ceiling panel 10. The plenum space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.). The building system 1 may be referred to as an acoustic building system 1—as discussed further herein.

In the installed state, the building panels 10 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid. The plenum space 3 exists above the ceiling support grid 6 and the active room environment 2 exists below the ceiling support grid 6. In the installed state, the first major exposed surface 11 of the building panel 10 may face the active room environment 2 and the second major exposed surface 12 of the building panel 10 may face the plenum space 3.

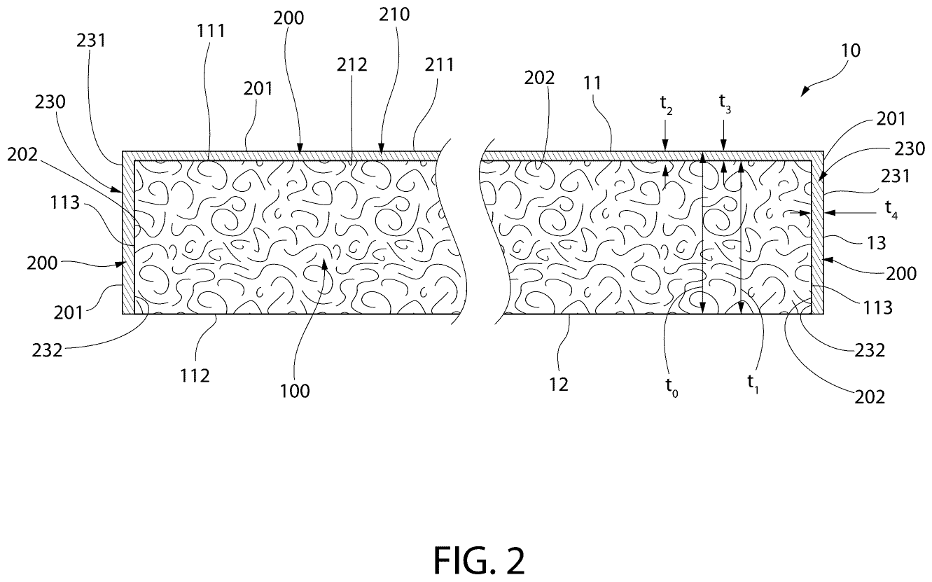

Referring now to FIGS. 1 and 2, the building panel 10 of the present invention may have a panel thickness to as measured from the first major exposed surface 11 to the second major exposed surface 12. The panel thickness to may range from about 12 mm to about 40 mm—including all values and sub-ranges there-between. The building panel 10 may have a length L_{P} ranging from about 30 cm to about 310 cm—including all values and sub-ranges there-between. The building panel 100 may have a width W_{P} ranging from about 10 cm to about 125 cm—including all values and sub-ranges there-between.

The building panel 10 may comprise a body 100 and a coating 200 applied thereto—as discussed further herein. The coating 200 may be referred to an “acoustic coating” 200 as well as a “visual concealment coating” 200.

According to the present invention, the coating 200 may be applied directly to the body 100. In a non-limiting embodiment, the building panel 10 may be free of a scrim. In particular, the coating 200 may be applied directed to the body 100 such that the coating 200 directly contacts the body 100—there being no scrim positioned between the coating 200 and the body 100.

The body 100 comprises an upper surface 111 (also referred to as a first major surface 111 of the body 100) opposite a lower surface 112 (also referred to as a second major surface 112 of the body 100) and a body side surface 113 (also referred to as a side surface 113 of the body 100) that extends between the upper surface 111 and the lower surface 112, thereby defining a perimeter of the body 100. The body 100 may have a body thickness t1 that as measured by the distance between the upper surface 111 to the lower surface 112 of the body 100. The body thickness t1 may range from about 12 mm to about 40 mm—including all values and sub-ranges there-between.

According to the present invention, the coating 200 may be applied directly to the first major surface 111 the body 100. In such embodiments, the building panel 10 may be free of a scrim such that the coating 200 may be applied directed to the first major surface 111 of the body 100 thereby contacting the first major surface 111 of the body 100—there being no scrim positioned between the coating 200 and the first major surface 111 of the body 100.

According to the present invention, the coating 200 may be applied directly to the second major surface 112 the body 100. In such embodiments, the building panel 10 may be free of a scrim such that the coating 200 may be applied directed to the second major surface 112 of the body 100 thereby contacting the second major surface 112 of the body 100—there being no scrim positioned between the coating 200 and the second major surface 112 of the body 100.

According to the present invention, the coating 200 may be applied directly to the side surface 113 of the body 100. In such embodiments, the building panel 10 may be free of a scrim such that the coating 200 may be applied directed to the side surface 113 of the body 100 thereby contacting the side surface 113 of the body 100—there being no scrim positioned between the coating 200 and the side surface 113 of the body 100.

The body 100 may be porous, thereby allowing airflow through the body 100 between the upper surface 111 and the lower surface 122—as discussed further herein. The body 100 may be comprised of a binder and fibers. The term “fibrous material” may be interchangeable with “fiber.” In some embodiments, the body 100 may further comprise a filler and/or additive.

Non-limiting examples of binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The fibers may be organic fibers, inorganic fibers, or a blend thereof. Non-limiting examples of inorganic fibers mineral wool (also referred to as slag wool), rock wool, stone wool, and glass fibers. Non-limiting examples of organic fiber include fiberglass, cellulosic fibers (e.g. paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof.

The porosity of the body 100 may allow for airflow through the body 100 under atmospheric conditions such that the building panel 10 may function as an acoustic building panel—specifically, an acoustic ceiling panel 10, which requires properties related to noise reduction and sound attenuation properties—as discussed further herein.

Specifically, the body 100 of the present invention may have a porosity ranging from about 60% to about 98%—including all values and sub-ranges there between. In a preferred embodiment, the body 100 has a porosity ranging from about 75% to 95%—including all values and sub-ranges there between. According to the present invention, porosity refers to the following:

$$\% Porosity = [ {V}_{Total} - ( {V}_{Binder} + {V}_{F} + {V}_{Filler} ) ] / {V}_{Total}$$

Where V_{Total} refers to the total volume of the body 100 defined by the upper surface 111, the lower surface 112, and the body side surfaces 113. V_{Binder} refers to the total volume occupied by the binder in the body 100. VF refers to the total volume occupied by the fibers in the body 100. V_{Filler} refers to the total volume occupied by the filler in the body 100. V_{HC} refers to the total volume occupied by the hydrophobic component in the body 100. Thus, the % porosity represents the amount of free volume within the body 100.

The building panel 10 of the present invention comprising the body 100 and the coating 200 may exhibit sufficient airflow for the building panel 10 to have the ability to reduce the amount of reflected sound in a room, thereby functioning as an acoustic building panel 10.

The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 10 of the present invention exhibits an NRC of at least about 0.5. In a preferred embodiment, the building panel 10 of the present invention may have an NRC ranging from about 0.60 to about 0.99—including all value and sub-ranges there-between.

The building panel 10 may exhibit an airflow resistance as measured between the first major exposed surface 111 and the second major exposed surface 112—the airflow resistance measured by the following formula:

$$R = ( {P}_{A} - {P}_{ATM} ) / \dot{V}$$

Where R is air flow resistance (measured in ohms); P_{A} is the applied air pressure; P_{ATM} is atmospheric air pressure; and \dot{V} is volumetric airflow. The airflow resistance may range from about 10 ohms to less than about 40 ohms—including all airflow resistances and sub-ranges there-between. In some embodiments, the airflow resistance may range from about 10 ohms to about 25 ohms—including all airflow resistances and sub-ranges there-between.

In some embodiments, the airflow resistance of the building panel 10 may be less than about 35 ohms. In some embodiments, the airflow resistance of the building panel 10 may be less than about 30 ohms. In some embodiments, the airflow resistance of the building panel 10 may be less than about 25 ohms. In some embodiments, the airflow resistance of the building panel 10 may be less than about 20 ohms. In some embodiments, the airflow resistance of the building panel 10 may be less than about 15 ohms.

The building panel 10 of the present invention may exhibit an airflow resistance of less than 40 ohms. In some embodiments, the building panel 10 of the present invention may exhibit an airflow resistance of less than 30 ohms. In some embodiments, the building panel 10 of the present invention may exhibit an airflow resistance of less than 20 ohms.

The surface coating 200 of the present invention may be applied to at least one of the first major surface 111 and/or the side surface 113 of the body 100. In some embodiments, the surface coating 200 of the present invention may be applied directly to at least one of the first major surface 111 and/or the side surface 113 of the body 100. In such embodiments, the coating 200 may directly contact the fibrous material present in the body 100.

In an alternative embodiment, the building panel 10 may comprise a scrim. The scrim may comprise a first major surface opposite a second major surface, whereby the second major surface contacts the upper surface 111 of the body 100. In such embodiments, the surface coating 200 may be applied to the first major surface of the scrim.

The surface coating 200 is formed from a coating composition that may comprise a foaming agent, a wetting agent, diatomaceous earth, and a pigment composition. The coating 200 composition may further comprise a binder. The coating 200 composition may further comprise a dispersant. The coating composition may further comprise one or more additives.

The surface coating 200 is present in a dry-state. According to the present invention, the phrase “dry-state” refers to the coating composition being substantially free of a liquid carrier (e.g., liquid water). Thus, the surface coating 200, which is in the dry-state, may comprise the pigment composition, binder, and additive while having less than about 0.1 wt. % of liquid carrier based on the total weight of the surface coating 200. In a preferred embodiment, the surface coating 200 in the dry-state has a solid's content of about 100 wt. % based on the total weight of the surface coating 200.

Conversely, the coating composition may be applied to either the body 100 or a scrim in a “wet-state,” which refers to the coating composition containing various amounts of liquid carrier—as discussed further herein. Therefore, in the wet-state, the coating composition may comprise at least liquid carrier and the pigment composition. In some embodiments, the coating composition in the wet-state may comprise liquid carrier, the pigment composition, and binder. In some embodiments, the coating composition in the wet-state may comprise liquid carrier, the pigment composition, binder, and one or more additives. The liquid carrier may be selected from water, VOC solvent—such as acetone, toluene, methyl acetate—or combinations thereof. In a preferred embodiment, the liquid carrier is water and comprises less than 1 wt. % of VOC solvent based on the total weight of the liquid carrier.

In the wet-state, the coating composition may have a solids content ranging from about 45 wt. % to about 75 wt. %—including all amounts and sub-ranges there-between. In some embodiments, the wet-state, the coating composition may have a solids content ranging from about 50 wt. % to about 60 wt. %—including all amounts and sub-ranges there-between.

The solid's content is calculated as the fraction of materials present in the coating composition that is not the liquid carrier. Specifically, the solid's content of the coating composition in the wet-state may be calculated as the total amount of the coating composition in the dry-state (i.e., the amount of pigment composition, binder, and additive) and dividing it by the total weight of the coating composition in the wet-state, including liquid carrier.

The coating 200 may comprise the foaming agent in an amount ranging from about 0.1 wt. % to about 1.0 wt. %—including all amounts and sub-ranges there-between—based on the total weight of the coating 200 in the dry-state. In some embodiments, the coating 200 may comprise the foaming agent in an amount ranging from about 0.1 wt. % to about 0.2 wt. %—including all amounts and sub-ranges there-between-based on the total weight of the coating 200 in the dry-state.

In a non-limiting embodiment, the coating 200 may comprise the foaming agent in an amount of about 1.0 wt. % based on the total weight of the coating 200 in the dry-state.

The foaming agent may be selected from one or more of the following compounds ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, monoethanolamine cocoyl sulfate, sodium trideceth-1 sulfate, sulfate, sodium trideceth-2 sulfate, sulfate, sodium trideceth-3 sulfate, sodium tridecyl sulfate, sodium methyl lauroyl taurate, sodium methyl cocoyl taurate, sodium lauroyl isethionate, sodium cocoyl isethionate, sodium laurethsulfosuccinate, sodium laurylsulfosuccinate, sodium tridecyl benzene sulfonate, sodium dodecyl benzene sulfonate, acyl isethionate, acyl methyl isethionate, acyl glutamate, acyl glycinate, acyl sarcosinate, acyl alaninate, acyl taurate, sulfosuccinate, alkyl benzene sulfonate, alkyl ether carboxylate, alkylamphoacetate, alpha olefin sulfonate, and mixtures thereof. Examples of such suitable anionic surfactants include, but not limited to, sodium cocoyl isethionate, sodium lauroyl isethionate, sodium lauroyl methyl isethionate, sodium cocoyl glutamate, disodium cocoyl glutamate, sodium lauroyl glutamate, disodium lauroyl glutamate, sodium cocoyl alaninate, sodium lauroyl alaninate, sodium lauroyl glycinate, sodium cocoyl glycinate, sodium laureth sulfosuccinate, disodium laureth sulfosuccinate, sodium lauryl sulfosuccinate, disodium lauryl sulfosuccinate, sodium lauryl glucose carboxylate, sodium cocoyl glucose carboxylate, sodium cocoyl amphoacetate, sodium lauroyl amphoacetate, sodium methyl cocoyl taurate, and mixtures thereof.

In some embodiments, the defoamer comprises a blend of sodium lauryl sulfate, disodium lauryl sulfosuccinate.

The coating 200 may comprise the wetting agent in an amount ranging from about 0.1 wt. % to about 2.0 wt. %—including all amounts and sub-ranges there-between—based on the total weight of the coating 200 in the dry-state. In some embodiments, the coating 200 may comprise the foaming agent in an amount ranging from about 0.1 wt. % to about 1.0 wt. %—including all amounts and sub-ranges there-between—based on the total weight of the coating 200 in the dry-state.

In a non-limiting embodiment, the coating 200 may comprise the wetting agent in an amount of about 0.33 wt. % based on the total weight of the coating 200 in the dry-state.

The wetting agent may comprise an amphoteric compound. The amphoteric compound may comprise both an anionic and cationic moiety. In some embodiments, the wetting agent may be substantially free of non-ionic compounds. In some embodiments, the wetting agent may be substantially free of cationic compounds even with the amphoteric compounds comprising a cationic moiety. Although the amphoteric compounds comprises a cationic moiety, the additional presence of the anionic moiety results in the overall compound being amphoteric, not cationic. As a result, the omission of “cationic” compounds in the wetting agent does not run afoul of the presence of the amphoteric surfactant.

In a non-limiting embodiment, the amphoteric compound may be selected from one or more of alkyl amineoxides, alkyl betaines, alkyl amidopropylbetaine, alkyl sulfobetaines, alkyl sultaines, dihydroxyl alky glycinate, alkyl ampho acetate, phospolipids, alkyl aminopropionic acids, alkyl imino monopropionic acids, alkyl imino dipropionic acids, or combinations thereof.

In some embodiments, the wetting agent comprises alkyl imino dipropionic acids.

The coating 200 may comprise the diatomaceous earth in an amount ranging from about 15.0 wt. % to about 35.0 wt. % based on the total weight of the coating 200 in the dry-state-including all percentages and sub-ranges there-between. In some embodiments, the coating composition may comprise the diatomaceous earth in an amount ranging from about 20 wt. % to about 30 wt. % based on the total weight of the coating 200—including all percentages and sub-ranges there-between. In some embodiments, the coating composition may comprise the diatomaceous earth in an amount ranging from about 24 wt. % to about 25 wt. % based on the total weight of the coating 200—including all percentages and sub-ranges there-between.

The diatomaceous earth may have a darcy value ranging from about 4 to about 12—including all values and sub-ranges there-between. A darcy value is a unit of permeability—whereby a permeability of 1 darcy permits a flow of 1 cm³/s of a fluid with viscosity 1 cP (1 mPa·s) under a pressure gradient of 1 atm/cm acting across an area of 1 cm².

In some embodiments, the diatomaceous earth may have a darcy value ranging from about 8.5 to about 11.5—including all values and sub-ranges there-between. In some embodiments, the diatomaceous earth may have a darcy value ranging from about 6.76 to about 9.0—including all values and sub-ranges there-between. In some embodiments, the diatomaceous earth may have a darcy value ranging from about 4.41 to about 5.29—including all values and sub-ranges there-between.

The coating 200 may comprise the pigment composition pigment composition in an amount ranging from about 85.0 wt. % to about 95.0 wt. %-based on the total weight of coating composition in the dry-state—including all weight percentages and sub-ranges there-between. In some embodiments, the coating 200 may comprise the pigment composition in an amount ranging from about 55 wt. % to about 75 wt. %—based on the total weight of coating 200 in the dry-state—including all weight percentages and sub-ranges there-between.

The pigment composition of the present invention may comprise one or more of titanium dioxide, calcium carbonate, calcined calcium carbonate, sodium silicate, magnesium sulfate, and barium sulfate. In some embodiments, the pigment composition of the present invention may comprise a blend of titanium dioxide and calcium carbonate. In some embodiments, the pigment composition of the present invention may comprise a blend of sodium silicate, magnesium sulfate, and barium sulfate.

In some embodiments, the titanium dioxide may be present in an amount ranging from about 0.0 wt. % to about 25.0 wt. % based on the total weight of the coating 200 in the dry-state—including all weight percentages and sub-ranges there-between. In some embodiments, the titanium dioxide may be present in an amount ranging from a non-zero amount to about 25.0 wt. % based on the total weight of the coating 200 in the dry-state—including all weight percentages and sub-ranges there-between.

In some embodiments, the calcium carbonate and/or calcined calcium carbonate may be present in an amount ranging from about 0.0 wt. % to about 35.0 wt. % based on the total weight of the coating 200 in the dry-state—including all weight percentages and sub-ranges there-between. In some embodiments, the calcium carbonate and/or calcined calcium carbonate may be present in an amount ranging from a non-zero amount to about 35.0 wt. % based on the total weight of the coating 200 in the dry-state—including all weight percentages and sub-ranges there-between.

In some embodiments, magnesium sulfate may be present in an amount ranging from about 0.0 wt. % to about 1.0 wt. % based on the total weight of the coating 200 in the dry-state—including all weight percentages and sub-ranges there-between. In some embodiments, magnesium sulfate may be present in an amount ranging from a non-zero amount to about 1.0 wt. % based on the total weight of the coating 200 in the dry-state—including all weight percentages and sub-ranges there-between.

In some embodiments, sodium silicate may be present in an amount ranging from about 0.0 wt. % to about 1.0 wt. % based on the total weight of the coating 200 in the dry-state—including all weight percentages and sub-ranges there-between. In some embodiments, sodium silicate may be present in an amount ranging from a non-zero amount to about 1.0 wt. % based on the total weight of the coating 200 in the dry-state—including all weight percentages and sub-ranges there-between.

In some embodiments, barium sulfate may be present in an amount ranging from about 0.0 wt. % to about 70.0 wt. % based on the total weight of the coating 200 in the dry-state—including all weight percentages and sub-ranges there-between. In some embodiments, barium sulfate may be present in an amount ranging from a non-zero amount to about 70.0 wt. % based on the total weight of the coating 200 in the dry-state—including all weight percentages and sub-ranges there-between.

The coating 200 may comprise one or more binders. The binder may be polymeric. The binder may have a glass transition temperature (“Tg”) that ranges from about −5° C. to about 60° C. —including all temperatures and sub-ranges there-between. In some embodiments, the binder may have a Tg that ranges from about 20° C. to about 40° C.—including all temperatures and sub-ranges there-between. In a preferred embodiment, the binder may have a Tg that ranges from about 25° C. to about 37° C.—including all temperatures and sub-ranges there-between. In a non-limiting embodiment, the Tg may be about 37° C.

Non-limiting examples of the binder include polymers selected from polyvinyl alcohol (PVOH), latex, an acrylic polymer, polymaleic anhydride, or a combination of two or more thereof. Non-limiting examples of latex binder may include a homopolymer or copolymer formed from the following monomers: vinyl acetate (i.e., polyvinyl acetate), vinyl propinoate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and an ester. Preferably the binder is selected from the group consisting of aqueous lattices of polyvinyl acetate, polyvinyl acrylic, polyurethane, polyurethane acrylic, polystyrene acrylic, epoxy, polyethylene vinyl chloride, polyvinylidene chloride, and polyvinyl chloride.

In a non-liming embodiment, the binder may be a polymeric composition that is formed by curing an alkyd resin (also referred to as an alkyd emulsion). Non-limiting examples of alkyd emulsion include polyester resins which include residues of polybasic, usually di-basic, acid(s) and polyhydroxy, usually tri- or higher hydroxy alcohols and further including monobasic fatty acid residues. The monobasic residues may be derived (directly or indirectly) from oils (fatty acid triglycerides) and alkyd resins are also referred to as oil modified polyester resins.

The alkyd resins may be cured from residual carboxyl and hydroxyl functionality or by unsaturation (often multiple unsaturation) in the monobasic fatty acid residues. Alkyd resins may include other residues and/or additives to provide specific functionality for the intended end use e.g. sources of additional carboxyl groups may be included to improve water compatibility. One or more catalyst may be blended with an alkyd resin to help accelerate curing.

Alkyd resins may be prepared by reacting a monobasic fatty acid, fatty ester or naturally occurring, partially saponified oil with a glycol or polyol and/or a polycarboxylic acid.

Non-limiting examples of monobasic fatty acid, fatty ester or naturally occurring-partially saponified oil may be prepared by reacting a fatty acid or oil with a polyol. Examples of suitable oils include sunflower oil, canola oil, dehydrated castor oil, coconut oil, corn oil, cottonseed oil, fish oil, linseed oil, oiticica oil, soya oil, and tung oil, animal grease, castor oil, lard, palm kernel oil, peanut oil, perilla oil, safflower, tallow oil, walnut oil. Suitable examples of the fatty acid components of oil or fatty acids by themselves are selected from the following oil derived fatty acids; tallow acid, linoleic acid, linolenic acid, oleic acid, soya acid, myristic acid, linseed acid, crotonic acid, versatic acid, coconut acid, tall oil fatty acid, rosin acid, neodecanoic, neopentanoic, isostearic, 12-hydroxystearic, cottonseed acid with linoleic, linolenic and oleic being more preferred

Non-limiting examples of suitable glycol or polyol include aliphatic, alicyclic, and aryl alkyl glycols. Suitable examples of glycols include: ethylene glycol; propylene glycol; diethylene glycol; triethylene glycol; tetraethylene glycol; pentaethylene glycol; hexaethylene glycol; heptaethylene glycol; octaethylene glycol; nonaethylene glycol; decaethylene glycol; 1,3-propanediol; 2,4-dimethyl-2-ethyl-hexane-1,3-diol; 2,2-dimethyl-1,2-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-tetramethyl-1,6-hexanediol; thiodiethanol; 1,2-cyclohexanedimethanol; 1,3-cyclohexanedimethanol; 1,4-cyclohexanedimethanol; 2,2,4-trimethyl-1,3-pentanediol; 2,2,4-tetramethyl-1,3-cyclobutanediol; p-xylenediol hydroxypivalyl hydroxypivalate; 1,10-decanediol; hydrogenated bisphenol A; trimethylolpropane; trimethylolethane; pentaerythritol; erythritol; threitol; dipentaerythritol; sorbitol; glycerine; trimellitic anhydride; pyromellitic dianhydride; dimethylolpropicnic acid and the like.

Non-limiting examples of polycarboxylic acid include isophthalic acid, terephthalic acid, phthalic anhydride (acid), adipic acid, tetrachlorophthalic anhydride, dodecanedioic acid, sebacic acid, azelaic acid, 1,4-cyclohexanedicarboxylic acid, 1,3-cyclohexanedicarboxylic acid, maleic anhydride, fumaric acid, succinic anhydride (acid), 2,6-naphthalenedicarboxylic acid, glutaric acid and esters thereof.

In some embodiments, the binder of the coating 200 may be polyvinyl acetate. The polyvinyl acetate may be a homopolymer. The polyvinyl acetate may have a pH of about 7.0. The polyvinyl acetate may have a Tg of about 37° C.

The binder may be present in an amount ranging from about 3.0 wt. % to about 10.0 wt. % based on the total weight of the coating 200 in the dry-state—including all weight percentages and sub-ranges there-between. In some embodiments, the binder may be present in an amount ranging from about 4.0 wt. % to about 8.0 wt. % based on the total weight of the coating 200 in the dry-state—including all weight percentages and sub-ranges there-between. In some embodiments, the binder may be present in an amount ranging from about 4.0 wt. % to about 7.0 wt. % based on the total weight of the coating 200 in the dry-state—including all weight percentages and sub-ranges there-between. In some embodiments, the binder may be present in an amount ranging from about 5.0 wt. % to about 7.0 wt. % based on the total weight of the coating 200 in the dry-state—including all weight percentages and sub-ranges there-between.

In some embodiments, the surface coating 200 may comprise boric acid in an amount ranging from about 0.0 wt. % to about 1.0 wt. % based on the total weight of the coating 200 in the dry-state—including all weight percentages and sub-ranges there-between. In some embodiments, boric acid may be present in an amount ranging from a non-zero amount to about 1.0 wt. % based on the total weight of the coating 200 in the dry-state—including all weight percentages and sub-ranges there-between.

The surface coating 200 may comprise one or more additives. Additives may be present in the coating 200 in an amount ranging from about 0.05 to about 3.0 wt. %-based on the total weight of the coating composition in the dry-state. Non-limiting examples of additives include rheology agents, preservatives, biocides, and the like.

In a non-limiting embodiment, rheology agents may include thickeners, such as thickening clays. Rheology agents may include hydophobically modified alkali-swellable emulsion, modified cellulose compounds, e.g., hydroxymethyl cellulose or hydroxypropyl cellulose, and combinations thereof.

Thickeners may be present in an amount ranging from about 0.01 wt. % to about 0.95 wt. % based on the weight of the surface coating 200 in the dry-state.

The coating 200 of the present invention—comprising the diatomaceous earth and pigment composition—imparts aesthetic hiding properties to the underlying body 100. The aesthetic hiding properties refers to the body 100 not being visually discernable through the coating 200 when viewed by the naked eye. In a non-limiting example, the first major surface 111 of the body 100 is coated with the coating 200, and the body 100 comprises the fibrous material, the first major surface 11 of the body 100 is not visually discernable when viewing the resulting first major exposed surface 11 of the building panel 10—which comprises the coating 200. The visual concealment of the underlying body 100, which is provided by the coating 200 may exist in the absence of a scrim layer that would otherwise be positioned between the coating 200 and the body 100. The coating 200 imparting such visual concealment to the body 100—thereby providing an aesthetically acceptable building panel 10—even in the absence of the scrim—provides a cost-effective alternative to producing aesthetically acceptable building materials.

Moreover, it has been surprisingly discovered that the combination of the foaming agent and wetting agent in the coating 200 comprising the diatomaceous earth results in an acoustically transparent coating 200 such that resulting building panel 10 may still exhibit the target airflow resistance values and/or NRC performance. Moreover, the acoustically transparent nature of the coating 200 does not undermine the visual concealment characteristics of such coating.

In fact, it has been surprisingly discovered that the coating 200 of the present invention exhibits an unexpected characteristic in that as greater amounts of the coating 200 is applied to the body 100—thereby enhancing the visual concealment of the underlying boy 100—the acoustic transparency of the coating 200 increases. Stated otherwise, as the amount of the coating 200 is applied increases—the visual concealment of the underlying body 100 improves while the resulting airflow resistance decreases (translating to a higher NRC value). Such phenomenon is surprisingly as previously it would be expected as greater amounts of coating is applied, airflow resistance would increase.

The building panel 10 according to the present invention may be formed by applying the coating composition in the wet-state to either the body 100 in an amount ranging from about 40.0 g/ft² to about 120.0 g/ft²—including all amounts and sub-ranges there-between. In some embodiments, the building panel 10 according to the present invention may be formed by applying the coating composition in the wet-state to either the body 100 in an amount ranging from about 60.0 g/ft² to about 90.0 g/ft²—including all amounts and sub-ranges there-between. Once applied, the coating composition in the wet-state may be dried at a temperature ranging from about 200° F. (93° C.) to about 350° F. (175° C.)—including all temperatures and sub-ranges there-between. The coating composition may be applied by spray, roll, or vacuum coating.

After drying, all liquid carrier is driven off thereby leaving the surface coating 200—i.e., the coating composition in the dry-state. The surface coating 200 may be present in an amount ranging from about 16.0 g/ft² to about 90.0 g/ft²—including all amounts and sub-ranges there-between. In some embodiments, the surface coating 200 may be present in an amount ranging from about 30.0 g/ft² to about 55.0 g/ft²—including all amounts and sub-ranges there-between.

The surface coating 200 may comprise an outer surface 201 opposite an inner surface 202. The inner surface 202 of the surface coating 200 faces toward the body 100 while the outer surface 201 of the surface coating 200 faces away from the body 100. The surface coating 200 may have a surface coating thickness t2 as measured from the outer surface 201 to the inner surface 202 of the surface coating 200.

The surface coating 200 may comprise a topcoat 210. The topcoat 210 may comprise an outer surface 211 opposite an inner surface 212. The topcoat 210 may have a topcoat thickness t3 as measured between the inner surface 212 and the outer surface 211 of the topcoat 210.

The topcoat 210 may be applied to the upper surface 111 of the body 100. Once applied, the inner surface 212 of the topcoat 210 faces the upper surface 111 of the body 100, and the outer surface 211 of the topcoat 210 forms the first major exposed surface 11 of the building panel 10. Stated otherwise, the first major exposed surface 11 of the building panel 10 may comprises the outer surface 211 of the topcoat 210.

The surface coating 200 may comprise an edge-coat 230. The edge-coat 230 may comprise an outer surface 231 opposite an inner surface 232. The edge-coat 210 may have a edge-coat thickness t4 as measured between the inner surface 232 and the outer surface 231 of the edge-coat 230.

The edge-coat 230 may be applied to the body side surface 113 of the body 100. Once applied, the inner surface 232 of the edge-coat 230 faces the body side surface 113 of the body 100 and the outer surface 231 of the edge-coat 230 forms the side exposed surface 13 of the building panel 10. Stated otherwise, the side exposed surface 13 of the building panel 10 may comprise the outer surface 231 of the edge-coat 230.

Although the building panel 10 shown in FIGS. 1 and 2 include both the topcoat 210 and the edge-coat 230, the present invention is not limited to surface coatings 200 that include both the topcoat 210 and the edge-coat 230. In some embodiments, the building panel 10 may comprise a surface coating 200 that includes only the topcoat 210—whereby the side exposed surface 13 of the building panel 10 is formed by the body side surface 113 of the body 100. In other embodiments, the building panel 10 may comprise a surface coating 200 that includes only the edge-coat 230—whereby first major exposed surface 11 of the building panel 10 is formed by either the upper surface 111 of the body 100, the first major surface of the scrim, or a coating applied thereto that is different from the surface coating 200 of the present invention.

### EXAMPLES

### Experiment 1

A first experiment was performed to test the impact of foaming agent, diatomaceous earth, and dispersants on acoustical performance and hiding performance. The experiment included a number of coating composition formulations that were applied to a major surface of a mineral wool panel body and dried. After each coating is dried, the acoustical performance was measured in ohms. Hiding performance was related to coating amount applied to the panel-whereby a minimum application amount threshold was determined to be sufficient to impart proper visual hiding properties to the underlying panel body without the presence of a decorative scrim layer positioned between.

The coating formulations are set forth below in Table 1. The details of each component are listed below:
Dispersant 1 (“D1”): hydrophobic copolymer polyelectrolyte dispersant having a pH of about 10.2 to about 10.6
Dispersant 2 (“D2”): sodium polyacrylate ionic dispersant
Wetting Agent 1 (“WA1”): amphoteric compound-including alkyl imino dipropionic acid, monosodium salt
Foaming Agent 1 (“FA1”): includes a blend of sodium lauryl sulfate and disodium lauryl sulfosuccinate
Foaming Agent 2 (“FA1”): Polyethylene glycol decyl ether
Diatomaceous Earth 1 (“DE1”): diatomaceous earth having a darcy value of 8.5-11.5
Pigment 1: blend of calcined kaolin, titanium dioxide, and calcium carbonate
Binder 1—polyvinyl acetate homopolymer having a pH of about 7.0 and a Tg of about 37° C.
Additive 1: biocide, rheology agent
Additive 2: biocide

TABLE 1

| | | | | Comp. |
|---|---|---|---|---|
| | Ex. 1 | Ex. 2 | Ex. 3 | Ex. 1 |
| D1 | 0.15 | — | 0.15 | 0.15 |
| D2 | — | 0.15 | — | — |
| WA1 | 0.33 | 0.33 | 0.33 | 0.33 |
| FA1 | 1.0 | 1.0 | 0.97 | — |
| FA2 | — | — | — | — |
| DE1 | 24.11 | 24.11 | 24.2 | 24.11 |
| Pigment | 67.93 | 67.93 | 69.16 | 68.87 |
| Binder 1 | 5.0 | 5.0 | 5.03 | 5.06 |
| Additive 1 | 1.48 | 1.48 | — | 1.48 |
| Additive 2 | — | — | 0.16 | — |

The coating formulations set forth in Table 1 were then applied in various amounts directly to a mineral wool substrate and the acoustic performance was then measured in ohms. The results are set forth below in Table 2. The application amounts are provided in the wet-state (with a corresponding solids content of the wet-state). The Ohms were recorded after each coating was dried.

TABLE 2

| | | Airflow |
|---|---|---|
| | Amount | Resistance |
| Coating | g/ft² | Ohms |
| Ex. 1 (57% solids) | 44.7 | 45.7 |
| Ex. 1 (57% solids) | 80.9 | 32.7 |
| Ex. 1 (57% solids) | 81.7 | 25.0 |
| Ex. 1 (57% solids) | 85.0 | 25.6 |
| Ex. 1 (57% solids) | 92.2 | 19.7 |
| Ex. 1 (57% solids) | 101.1 | 13.1 |
| Ex. 1 (51% solids) | 54.0 | 48.4 |
| Ex. 1 (51% solids) | 60.0 | 75.1 |
| Ex. 1 (51% solids) | 70.0 | 38.1 |
| Ex. 1 (51% solids) | 86.6 | 34.6 |
| Ex. 1 (51% solids) | 87.4 | 43.8 |
| Ex. 1 (51% solids) | 113 | 28.9 |
| Ex. 2 (57% solids) | 54.9 | 50.1 |
| Ex. 2 (57% solids) | 88.3 | 40.8 |
| Ex. 2 (57% solids) | 99.1 | 38.8 |
| Ex. 3 (57% solids) | 39.3 | 40.4 |
| Ex. 3 (57% solids) | 85.0 | 22.3 |
| Ex. 3 (57% solids) | 88.1 | 21.1 |
| Ex. 3 (57% solids) | 99.0 | 19.0 |
| Comp. Ex. 1 (57% solids) | 68.8 | 53.3 |
| Comp. Ex. 1 (57% solids) | 73.2 | 57.3 |
| Comp. Ex. 1 (57% solids) | 80.3 | 57.4 |
| Comp. Ex. 1 (57% solids) | 99 | 62.6 |
| Comp. Ex. 1 (57% solids) | 137 | 69.2 |

As demonstrated by Tables 1 and 2, the combination of foaming agent and the specific amphoteric wetting agent in the coating comprising the diatomaceous earth results in dry coating that exhibits acoustically transparent performance—as based on the required threshold of being less than 40 ohms—preferably, less than 30 ohms.

The unexpected synergy of the present invention between foaming agent and the specific wetting agent in the coating comprising diatomaceous earth is evidenced by the comparison of the coatings of Ex. 1-3 (all of which contain a foaming agent) vs. Comp. Ex. 1 (which is otherwise identical except is free of a foaming agent). Such comparison shows the absence of foaming agent results in a coating (i.e., the coating of Comp. Ex. 1) that never reaches an airflow resistance of less than 50, which is unacceptable for the required acoustical performance.

Moreover, the recorded airflow resistance of each of coatings of Ex. 1-3 further reflect an unexpected advantage in that as application amount increases, the recorded airflow resistance decreased. Such phenomenon is truly surprising as previously, it was expected to increase airflow resistance as greater amounts of coating are applied to a surface—however—the present invention provides a newly discovered synergy between the foaming agent and wetting agent in diatomaceous earth containing coating-whereby additional amounts of such coating exhibit improved air-flow porosity through the coating, thereby achieving the desired airflow resistances (i.e., less than 40, preferably less than 30). Such discovery is especially significant because additional amounts of such coating may provide visual hiding characteristics to the underlying substrate—in this case, a mineral body—such that the underlying body can be visually concealed by the coating without the need of an intermediary cosmetic layer (e.g., a scrim) without ultimately preventing the resulting panel from functioning as an acoustic panel.

### Experiment 2

A second experiment was performed to test the impact of various types of diatomaceous earth. The additional formulations are provided below in Table 3. The additional components of Experiment 2 are listed below:
Diatomaceous Earth 2 (“DE2”): diatomaceous earth having a darcy value of 6.76-9.0
Diatomaceous Earth 3 (“DE3”): diatomaceous earth having a darcy value of 4.41-5.29

TABLE 3

| | Ex. 1 | Ex. 4 | Ex. 5 |
|---|---|---|---|
| D1 | 0.15 | 0.15 | 0.15 |
| WA1 | 0.33 | 0.33 | 0.33 |
| FA1 | 1.0 | 1.0 | 1.0 |
| DE1 | 24.11 | — | — |
| DE2 | — | 24.11 | — |
| DE3 | — | — | 24.11 |
| Pigment | 67.93 | 67.93 | 67.93 |
| Binder 1 | 5.0 | 5.0 | 5.0 |
| Additive 1 | 1.48 | 1.48 | 1.48 |

The coating formulations set forth in Table 3 were then applied in various amounts directly to a mineral wool substrate and the acoustic performance was then measured in ohms. The results are set forth below in Table 4. The application amounts are provided in the wet-state (with a corresponding solids content of the wet-state). The Ohms were recorded after each coating was dried.

TABLE 4

| | | |
|---|---|---|
| Ex. 4 (57% solids | 49.0 | 38.6 |
| Ex. 4 (57% solids | 64.2 | 36.4 |
| Ex. 4 (57% solids) | 68.1 | 33.5 |
| Ex. 4 (57% solids | 105 | 20.3 |
| Ex. 4 (57% solids | 137 | 16.6 |
| Ex. 5 (57% solids) | 60.0 | 43.3 |
| Ex. 5 (57% solids | 67.4 | 43.6 |
| Ex. 5 (57% solids) | 82.0 | 35.9 |
| Ex. 5 (57% solids | 103.0 | 38.8 |
| Ex. 5 (57% solids) | 128.0 | 19.6 |

As demonstrated by Tables 3 and 4, the airflow resistance of the coating may be further fine-tuned without requiring solely on presence (or absence) of foaming agent and/or selection of wetting agent-rather, it has also been surprisingly discovered that the type of diatomaceous earth impacts the airflow resistance at varying coating amounts. Therefore, depending on the level of visual concealment needed by the coating based on a desired application amount—the desired airflow resistance may still be achieved by selecting one or more of DE1, DE2, or DE3.

### Experiment 3

A third experiment was performed to test the impact of various amounts of binder. The additional formulations are provided below in Table 5.

TABLE 5

| | Ex. | Ex. | Comp. |
|---|---|---|---|
| | 1 | 6 | Ex. 2 |
| D1 | 0.15 | 0.15 | 0.15 |
| WA1 | 0.33 | 0.33 | 0.33 |
| FA1 | 1.0 | 1.0 | 1.0 |
| DE1 | 24.11 | 23.67 | 26.11 |
| Pigment | 67.93 | 66.36 | 67.93 |
| Binder 1 | 5.0 | 7.01 | 3.0 |
| Additive 1 | 1.48 | 1.48 | 1.48 |

The coating formulations set forth in Table 5 were then applied in various amounts directly to a mineral wool substrate and the acoustic performance was then measured in ohms. The results are set forth below in Table 6. The application amounts are provided in the wet-state (with a corresponding solids content of the wet-state). The Ohms were recorded after each coating was dried.

TABLE 6

| | | |
|---|---|---|
| Ex. 6 (57% solids) | 70.4 | 43.3 |
| Ex. 6 (57% solids) | 83.0 | 43.6 |
| Ex. 6 (57% solids) | 112.0 | 35.9 |
| Ex. 6 (57% solids) | 130.0 | 38.8 |
| Comp. Ex. 2 (51% solids) | 62 | 80.0 |
| Comp. Ex. 2 (51% solids) | 78 | 100.0 |
| Comp. Ex. 2 (51% solids) | 96 | 120.0 |
| Comp. Ex. 2 (51% solids) | 114 | 133.4 |
| Comp. Ex. 2 (51% solids) | 127 | 307.0 |

As demonstrated by Tables 5 and 6, the amount of binder may be increased to 7 wt. % while still being able to achieve an acceptable airflow resistance (i.e., less than 40 ohms at 112 g/ft²). However, surprisingly, at binder levels of 3 wt. %, the airflow resistance becomes exceeding high-much too high for acoustical applications. Such phenomenon is truly surprising as previously, it was expected that as binder is decreased, the airflow resistance of a coating would also decrease-which may be suitable in coatings requiring larger amounts of binder for strength purposes.

### Experiment 4

A fourth experiment was performed to test the impact of type of binder. The additional formulations are provided below in Table 7. The additional components of Experiment 4 are listed below:
Binder 2-vinyl-acrylic polymer
Binder 3-blend of latex polymer and water soluble methacrylate copolymer
Binder 4-acrylic polymer dispersion
Binder 5-vinyl-acrylic polymer

TABLE 7

| | | | | | | Comp. | Comp. |
|---|---|---|---|---|---|---|---|
| | Ex. 1 | Ex. 7 | Ex. 8 | Ex. 9 | Ex. 10 | Ex. 3 | Ex. 4 |
| D1 | 0.15 | 0.15 | 0.15 | 0.38 | 0.15 | 0.15 | 0.15 |
| WA1 | 0.33 | 0.33 | 0.33 | 0.33 | 0.33 | 0.33 | 0.33 |
| FA1 | 1.0 | 1.0 | 1.0 | 1.0 | 1.0 | 1.0 | 1.0 |
| DE1 | 24.11 | 24.11 | 24.11 | 24.11 | 24.11 | 24.11 | 24.11 |
| Pigment | 67.93 | 67.93 | 67.93 | 67.7 | 67.93 | 67.93 | 67.93 |
| Binder 1 | 5.0 | — | — | — | — | — | — |
| Binder 2 | — | — | — | — | — | 5.0 | — |
| Binder 3 | — | — | — | — | — | — | 5.0 |
| Binder 4 | — | 5.0 | — | — | — | — | — |
| Binder 5 | — | — | 5.0 | 5.0 | 5.0 | — | — |
| Additive | 1.48 | 1.48 | 1.48 | 1.48 | 1.48 | 1.48 | 1.48 |
| 1 | | | | | | | |

The coating formulations set forth in Table 7 were then applied in various amounts directly to a mineral wool substrate and the acoustic performance was then measured in ohms. The results are set forth below in Table 8. The application amounts are provided in the wet-state (with a corresponding solids content of the wet-state). The Ohms were recorded after each coating was

TABLE 8

| | | |
|---|---|---|
| Ex. 7 (57% solids) | 60 | 51.1 |
| Ex. 7 (57% solids) | 70 | 42.1 |
| Ex. 7 (57% solids) | 88.2 | 36.1 |
| Ex. 7 (57% solids) | 90.2 | 34.4 |
| Ex. 7 (57% solids) | 100.1 | 36.9 |
| Ex. 8 (57% solids) | 76 | 46.36 |
| Ex. 8 (57% solids) | 80 | 39.4 |
| Ex. 8 (57% solids) | 120 | 56.1 |
| Ex. 9 (57% solids) | 40.0 | 28.2 |
| Ex. 9 (57% solids) | 70.0 | 34.1 |
| Ex. 9 (57% solids) | 80.0 | 31.9 |
| Ex. 9 (57% solids) | 100.0 | 32.08 |
| Ex. 9 (57% solids) | 120.0 | 27.7 |
| Comp. Ex. 3 (57% solids) | 43.2 | 48.0 |
| Comp. Ex. 3 (57% solids) | 53.2 | 53.0 |
| Comp. Ex. 3 (57% solids) | 66.1 | 45.5 |
| Comp. Ex. 3 (57% solids) | 73.1 | 45.2 |
| Comp. Ex. 3 (57% solids) | 78.0 | 47.2 |
| Comp. Ex. 4 (57% solids) | 53.8 | 59.1 |
| Comp. Ex. 4 (57% solids) | 66.96 | 57.7 |
| Comp. Ex. 4 (57% solids) | 75.0 | 61.7 |
| Comp. Ex. 4 (57% solids) | 94.0 | 67.1 |
| Comp. Ex. 4 (57% solids) | 110.0 | 80.0 |

As demonstrated by Tables 7 and 8, the binder selection may include a variety of binders—such as Binder 1, Binder 4, and Binder 5. To be clear, Binder 4 does achieve an acceptable acoustic performance by recording an ohm value of less than 40 in at least one application amount. Moreover, it has been surprisingly discovered that ohm performance can be improved by increasing the amount of dispersant—as evidenced by the increase in D1 in Ex. 9 compared to that of Ex. 8, with a corresponding reduction in airflow resistance. The coatings of Comp. Ex. 4 and 5, however, never achieve an acceptable acoustic performance (ohm values are never less than 45).

### Experiment 5

A fifth experiment was performed to test the impact of pigment. The additional formulations are provided below in Table 9. The additional components of Experiment 4 are listed below:
Pigment 2: blend of sodium silicate, magnesium sulfate, and barium sulfate
Pigment 3: blend of titanium dioxide and barium sulfate

TABLE 9

| | Ex. | Ex. | Comp. |
|---|---|---|---|
| | 1 | 10 | Ex. 5 |
| D1 | 0.15 | 0.15 | 0.15 |
| WA1 | 0.33 | 0.33 | 0.33 |
| FA1 | 1.0 | 1.0 | 1.0 |
| DE1 | 24.11 | 24.04 | 24.11 |
| Pigment 1 | 67.93 | — | — |
| Pigment 2 | — | 68.0 | — |
| Pigment 3 | — | — | 67.93 |
| Binder 1 | 5.0 | 5.0 | 5.0 |
| Additive 1 | 1.48 | 1.48 | 1 1.48 |

The coating formulations set forth in Table 9 were then applied in various amounts directly to a mineral wool substrate and the acoustic performance was then measured in ohms. The results are set forth below in Table 10. The application amounts are provided in the wet-state (with a corresponding solids content of the wet-state). The Ohms were recorded after each coating was dried.

TABLE 9

| | | |
|---|---|---|
| Ex. 10 (57% solids) | 70.0 | 14.7 |
| Ex. 10 (57% solids) | 76.0 | 15.5 |
| Ex. 10 (57% solids) | 83.0 | 11.6 |
| Ex. 10 (57% solids) | 100.0 | 10.5 |
| Ex. 10 (57% solids) | 103.0 | 13.1 |
| Comp. Ex. 5 (57% solids) | 75.0 | 42.8 |
| Comp. Ex. 5 (57% solids) | 80.0 | 41.7 |
| Comp. Ex. 5 (57% solids) | 90.7 | 40.0 |
| Comp. Ex. 5 (57% solids) | 123.0 | 49.4 |
| Comp. Ex. 5 (57% solids) | 136.0 | 41.7 |

As demonstrated by Tables 9 and 10, in addition to the Pigment 1 blend, the coating may comprise barium sulfate in combination with sodium silicate and magnesium sulfate without sacrifice of acoustic properties.

1. An acoustic building panel comprising:
a body having a first major surface opposite a second major surface and a side surface extending there-between;
a coating applied to at least one of the first major surface, the second major surface, or the side surface, the coating comprising:
a foaming agent;
a wetting agent;
diatomaceous earth;
a pigment composition; and
wherein the coating is present in an amount ranging from about 16 g/ft² to about 90 g/ft².

2. The acoustic building panel according to claim 1, wherein the wetting agent is an amphoteric compound.

3. The acoustic building panel according to claim 2, wherein the amphoteric compound comprises alkyl imino dipropionic acid.

4. The acoustic building panel according to claim 1, wherein the wetting agent is present in an amount ranging from about 0.1 wt. % to about 1.0 wt. % based on the total weight of the coating.

5. The acoustic building panel according to claim 1, wherein the diatomaceous earth is present in an amount ranging from about 20 wt. % to about 30 wt. % based on the total weight of the coating composition.

6-7. (canceled)

8. The acoustic building panel according to claim 1, wherein the pigment composition comprises titanium dioxide and calcium carbonate.

9. The acoustic building panel according to claim 1, wherein the pigment composition comprises sodium silicate, magnesium sulfate, and barium sulfate.

10. The acoustic building panel according to claim 1, wherein the coating further comprises a binder.

11. (canceled)

12. The acoustic building panel according to claim 10, wherein the binder comprises polyvinyl acetate.

13-15. (canceled)

16. The acoustic building panel according to claim 1, wherein the body comprises inorganic fiber and the coating is directly applied to the body.

17-40. (canceled)

41. An acoustic building panel comprising:
a body having a first major surface opposite a second major surface and a side surface extending there-between, the body comprising an inorganic fiber;
a coating comprising:
a binder present in an amount ranging from about 3 wt. % to about 8 wt. % based on the total weight of the coating;
a foaming agent present in an amount ranging from about 0.1 wt. % to about 2.0 wt. %;
a wetting agent comprising an amphoteric compound, the wetting agent present in an amount ranging from about 0.1 wt. % to about 1.0 wt. % based on the total weight of the coating;
diatomaceous earth present in an amount ranging from about 20 wt. % to about 30 wt. % based on the total weight of the coating; and
a pigment composition in an amount ranging from about 50 wt. % to about 75 wt. % based on the total weight of coating;
wherein the coating is applied directly to at least one of the first major surface of the body, the second major surface of the body, or the side surface of the body.

42. The acoustic building panel according to claim 41, wherein the amphoteric compound comprises alkyl imino dipropionic acid.

43. The acoustic building panel according to claim 41, wherein the diatomaceous earth has a darcy value ranging from about 4 to about 12.

44. The acoustic building panel according to claim 41, wherein the pigment composition comprises one or more of titanium dioxide, calcium carbonate, sodium silicate, magnesium sulfate, and barium sulfate.

45. The acoustic building panel according to claim 41, wherein the binder comprises polyvinyl acetate.

46-53. (canceled)

54. A coating composition for the production of acoustic building panels, the coating composition comprising:
a liquid carrier;
a solid component comprising:
a foaming agent;
a wetting agent;
diatomaceous earth;
a pigment composition; and
wherein the coating composition has a solids content ranging from about 45 to about 75 based on the total weight of the coating composition.

55. The coating composition according to claim 54, wherein the amphoteric compound comprises alkyl imino dipropionic acid.

56-57. (canceled)

58. The coating composition according to claim 54 to 57, wherein the diatomaceous earth has a darcy value ranging from about 4 to about 12.

59. (canceled)

60. The coating composition according to claim 54, wherein the pigment composition comprises titanium dioxide and calcium carbonate.

61. (canceled)

62. The coating composition according to claim 54, wherein the coating further comprises a binder.

63-81. (canceled)
